(19) United States
(12) Patent Application Publication
(10) Pub. No.: US 2002/0130757 A1
(43) Pub. Date: Sep. 19, 2002

(54) Surface mountable polymeric circuit protection device and its manufacturing process

(75) Inventors: Chien-Shan Huang, Taipei Hsien (TW); Ren-Haur Hwang, Taoyuan City (TW); Chen-Ron Lin, Hsinchu (TW)

Correspondence Address: Ladas & Parry, 26 West 61st Street, New York, NY, 10023, US

(73) Assignee: PROTECTRONICS TECHNOLOGY CORPORATION

(21) Appl. No.: 09/999,376

(22) Filed: Oct. 31, 2001

(30) Foreign Application Priority Data
Mar. 13, 2001 (TW) 090105754

(51) Int. Cl. H01C 7/10

(52) U.S. Cl. 338/22 R

(57) ABSTRACT

The present invention discloses a surface mountable polymeric circuit protection device. The surface mountable polymeric circuit protection device is formed by configuring a conductive polymeric element having PTC features in combination with a top electrode, a bottom electrode and an insulative layer therebetween without conductive mechanisms between the top and the bottom electrodes.

### BACKGROUND OF THE INVENTION

(A) Field of the Invention

The present invention relates to a surface mountable polymeric circuit protection device, and more particularly to a surface mountable polymeric circuit protection device having positive temperature coefficient (PTC) features.

(B) Description of Related Art

PTC devices are already widely used in many fields, such as temperature detection, security control, temperature compensation, and so on. In the past, a thermal sensitive resistance device mainly utilizes ceramic material, but a high temperature, in most cases a temperature higher than 900° C., is needed to manufacture ceramic material . Thus energy consumption is enormous, and the process is very complex. Later on, a thermal sensitive resistance device utilizing a polymeric substrate has been developed. As the manufacturing temperature of a thermal sensitive resistance device employing a polymeric substrate is under 300° C., the manufacturing and molding processes are easier, energy consumption is lowered, process is simplified, and manufacturing cost is reduced. Its application therefore becomes more and more popular as time goes on.

U.S. Pat. No. 5,852,397 discloses a PTC circuit protection device using a conductive polymeric material. The conductive polymeric material having PTC features is in a low resistance status under room temperature. When a current flowing through the polymeric material is large enough and causes the temperature of the polymeric material to reach a switching temperature (Ts), the resistance of the polymeric material increases rapidly. Therefore, the polymeric material can be applied to current overload protection devices and temperature switch devices. This is because the conductive particles filled in the polymeric material are in a interconnected conductive status under room temperature. When the temperature exceeds the switching temperature, volume of resin substrate in the polymeric material expands and causes the linking conductive particles filled in the polymeric material to break down from a continuous status to a discontinuous status. Therefore, the resistance of the PTC circuit protection device increases rapidly and cuts off current so as to provide current overload protection and temperature control. The conductive particle filled in the polymeric material is carbon black.

To meet the requirement of surface-mounting the PTC circuit protection device on a printed circuit board, the PTC circuit protection device using a conductive polymeric element having PTC features is packaged as a surface mountable device. The difference between the surface mountable PTC circuit protection device and the conventional plug-in type PTC circuit protection device resides in that the two end electrodes of the surface mountable PTC circuit protection device are manufactured on the same plane of the device.

Referring to FIG. 1, a PTC circuit protection device 10 using a conductive polymeric element 12 having PTC features is disclosed in U.S. Pat. No. 5,852,397. A plate through hole 11 is used to conduct a top electrode 13 and a first bottom electrode 14. Then an insulative layer 16 is formed between the first bottom electrode 14 and a second bottom electrode 15. The volume resistivity of an ordinary electrode material, such as nickel and copper, is in the range from 10⁻⁵ ohm-cm to 10⁻⁶ ohm-cm, while the volume resistivity of carbon black is in the range from 10⁻¹ ohm-cm to 10⁻² ohm-cm. In addition, the volume resistivity of the polymeric material filled with carbon black under room temperature is more than 10⁻¹ ohm-cm to 10⁻² ohm-cm. When the temperature exceeds the switching temperature, the volume resistivity of the polymeric material increases rapidly and is much larger than the volume resistivity of a metallic electrode. Therefore, when a current flows into the circuit protection device 10 having two end electrodes (the first bottom electrode 14 and the second bottom electrode 15), the main voltage drop occurs at the conductive polymeric element 12 having PTC features between the first top electrode 13 and the second bottom electrode 15. The plate through hole 11, the top electrode 13 and the first bottom electrode 14 has similar voltage potentials and every position of the second bottom electrode 15 has another similar voltage potentials.

Another surface mountable PTC circuit protection device using a conductive polymeric material having PTC features and the method thereof are disclosed in U.S. Pat. No. 5,900,800. Referring to FIG. 2, the periphery of a PTC circuit protection device 20 constituted by a conductive polymeric element having PTC features 21, a bottom electrode 22 and a top electrode 23 are etched except for a lateral end portion 24 adjacent to the bottom electrode 22 and a lateral end portion 25 adjacent to the top electrode 23 for forming electrodes, and the circuit protection device 20 is isolated from the peripheral elements thereof by a first insulative layer 26 and a second insulative layer 27. A first lateral conductive layer 28 is conducted to the bottom electrode 22 through the exposed end portion 24 of the bottom electrode 22. Meantime, a second lateral conductive layer 29 is conducted to the top electrode 23 through the exposed end portion 25 of the top electrode 23. Therefore, conducting the top electrode 23 to the bottom electrode 22 through the external conductive layers 28 and 29 forms the PTC circuit protection device 20 having two end electrodes on the same plane.

The surface mountable polymeric circuit protection devices disclosed in U.S. Pat. Nos. 5,852,397 and 5,900,800 both utilize a conductive mechanism for conducting the first electrode and the second electrode. The difference resides in that U.S. Pat. No. 5,852,397 utilizes plate through holes as conductive mechanisms while U.S. Pat. No. 5,900,800 utilizes lateral conductive layers as conductive mechanisms. However, no matter whether the plate through holes or the lateral conductive layers will limit the expansion of the conductive polymeric material having PTC features when temperature increases, the conductive polymeric material cannot be fully expanded and the optimum breakdown property cannot be achieved.

In addition, the metallic foil and conductive polymeric material having PTC features are directly used in the manufacturing processes of U.S. Pat. Nos. 5,852,397 and 5,900,800. The material is softer and is easily warped and deformed. Therefore, its dimension stability is not good.

### OBJECTS OF THE INVENTION

An object of the present invention is to provide a surface mountable polymeric circuit protection device. The surface mountable polymeric circuit protection device is formed by configuring a conductive polymeric element having PTC features in combination with a top electrode, a bottom electrode and a lateral insulative layer therebetween without conductive mechanisms between the top electrode and the bottom electrode.

Another object of the present invention is to provide a surface mountable polymeric circuit protection device, such that the conductive polymeric material having PTC features therein is expanded sufficiently and broken down to a discontinuous status when the temperature increases due to the current overload, whereby an optimum breakdown property is obtained when the current is overload.

Another object of the present invention is to provide a polymeric circuit protection device and the method thereof so that the manufacturing processes are simplified and the dimension stability is increased.

### SUMMARY OF THE INVENTION

To achieve the objects described above and other effects, the surface mountable polymeric circuit protection device of the present invention comprises a first electrode, a first polymeric element having PTC features, a second polymeric element having PTC features, a second electrode and a third electrode. A second surface of the first electrode is conducted to a first surface of the first polymeric element and a first surface of the second polymeric element. A first surface of the second electrode is conducted to a second surface of the first polymeric element. A first surface of the third electrode is conducted to a second surface of the second polymeric element. A third surface of the first polymeric element is not directly contacted to a third surface of the second polymeric element. Therefore, if a current flows into the surface mountable polymeric circuit protection device of the present invention, the current flows from the second electrode to the first polymeric element, the first electrode, the second polymeric element and then the third electrode sequentially.

The method for manufacturing the surface mountable polymeric circuit protection device of the present invention first arranges a first metallic electrode layer, a first polymeric layer having PTC features and a second metallic electrode layer sequentially and then thermally presses the above layers to form a multi-layer circuit laminated structure. Then the multi-layer circuit laminated structure is divided to form a second electrode and a third electrode on the second metallic electrode layer. A first polymeric element and a second polymeric element are then formed on the first polymeric material layer, wherein the second electrode, the third electrode, the first polymeric element, and the second polymeric element are separated from by a trench respectively. Finally, an end electrode is formed to the second electrode and the third electrode respectively.

In view of the above, the surface mountable polymeric circuit protection device of the present invention does not provide conductive mechanisms among the first, second and third electrodes. In addition, because there are no internal or external conductive mechanisms, the conductive polymeric material having PTC features therein is expanded sufficiently and broken down to a discontinuous status when the temperature increases' due to the current overload, whereby an optimum breakdown property is obtained when the current is overloaded.

### DESCRIPTION OF THE DRAWINGS

The present invention is described below by way of examples with reference to the accompanying drawings which will make readers easier to understand the objects, technical contents, characteristics and achievement of the present invention, wherein

FIG. 1 is a schematic diagram of a conventional circuit protection device;

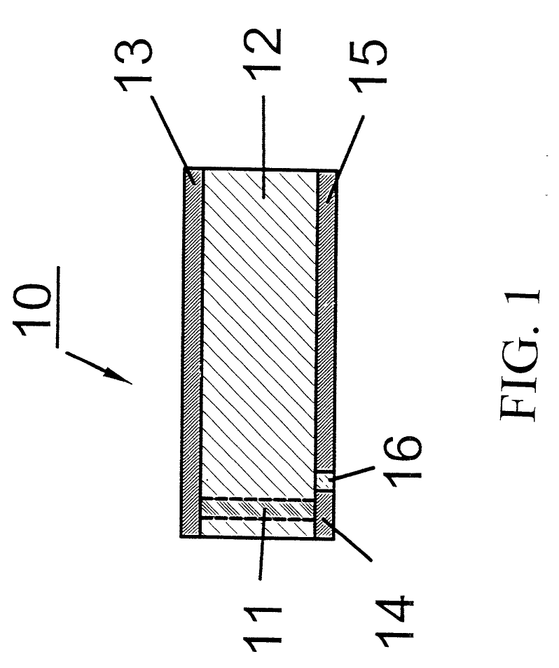

FIG. 2 is a schematic diagram of another conventional circuit protection device;

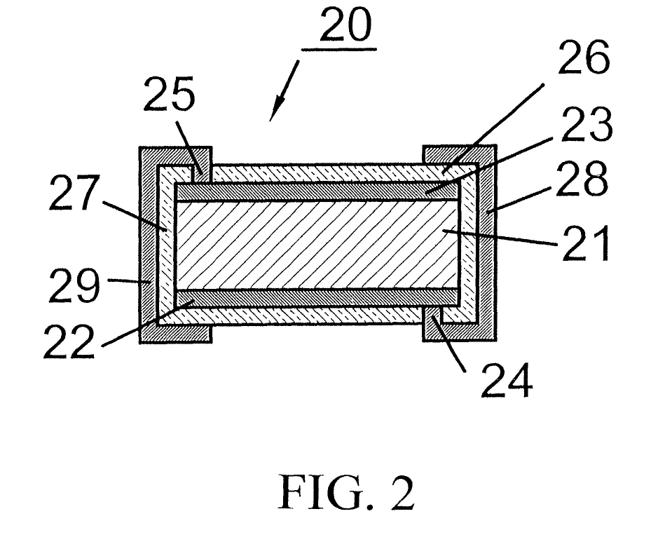

FIG. 3 is a cross-sectional view of the basic structure of the circuit protection device of a first embodiment of the present invention;

FIG. 4 is a cross-sectional view of the nickel plated copper foil of the circuit protection device of the first embodiment of the present invention;

FIG. 5 is a cross-sectional view of the multi-layer circuit laminated structure of the circuit protection device of the first embodiment of the present invention;

FIG. 6 is a cross-sectional view of the manufacturing process of the circuit protection device of the first embodiment of the present invention;

FIG. 7 is a cross-sectional view of another manufacturing process of the circuit protection device of the first embodiment of the present invention;

FIG. 8 is the circuit protection device of the first embodiment of the present invention;

FIG. 9 is a cross-sectional view of the double-sided metallic foil clad substrate of the circuit protection device of a second embodiment of the present invention;

FIG. 10 is a cross-sectional view of the metallic foil of the circuit protection device of the second embodiment of the present invention;

FIG. 11 is a cross-sectional view of the multi-layer circuit laminated structure of the circuit protection device of the second embodiment of the present invention;

FIG. 12 is the circuit protection device of the second embodiment of the present invention;

FIG. 13 is a cross-sectional view of the double-sided metallic foil clad substrate of the circuit protection device of a third embodiment of the present invention;

FIG. 14 is a cross-sectional view of the manufacturing process of double-sided metallic foil clad substrate of the circuit protection device of the third embodiment of the present invention;

FIG. 15 is a cross-sectional view of the multi-layer circuit laminated structure of the circuit protection device of the third embodiment of the present invention;

FIG. 16 is a cross-sectional view of another manufacturing process of the circuit protection device of the third embodiment of the present invention;

FIG. 17 is a cross-sectional view of a manufacturing process of the circuit protection device of the third embodiment of the present invention;

FIG. 18 is a cross-sectional view of another manufacturing process of the circuit protection device of the third embodiment of the present invention;

FIG. 19 is the circuit protection device of the third embodiment of the present invention.

### DETAILED DESCRIPTION OF THE INVENTION

### First Embodiment

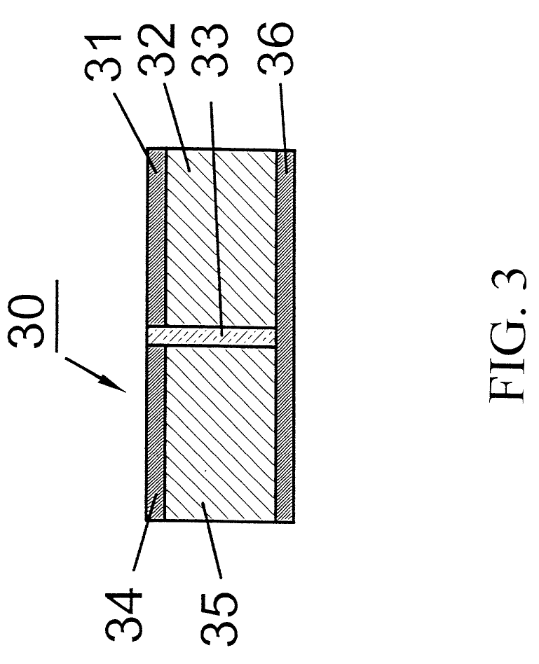

A structural diagram of the first embodiment of the present invention is illustrated in FIG. 3. In the PTC circuit protection device 30 of the present embodiment, a first portion 31 of a top electrode and a first portion 32 of a conductive polymer element having PTC features are isolated from a second portion 34 of the top electrode and a second portion 35 of the conductive polymer element having PTC features by an insulating layer 33. The first portion 31 and the second portion 34 of the top electrode, which are disposed at the same plane, are taken as two end electrodes of the PTC circuit protection device 30, such that the first portion 32 and the second portion 35 of the conductive polymer element having PTC features form a series connection via a bottom electrode 36.

A current will not flow from the first portion 32 of the conductive polymer element having PTC features to the second portion 35 of the conductive polymer element having PTC features through the insulating layer 33 because the resistance of the insulating layer 33 is much larger than the resistance of the first portion 32 of the conductive polymer element having PTC features and the second portion 35 of the conductive polymer element having PTC features. Thus, the current flows into the device from the first portion 31 of the top electrode, and then through the first portion 32 of the conductive polymer element having PTC features, the bottom electrode 36, the second portion 35 of the conductive polymer element having PTC features, and finally the other end electrode 34.

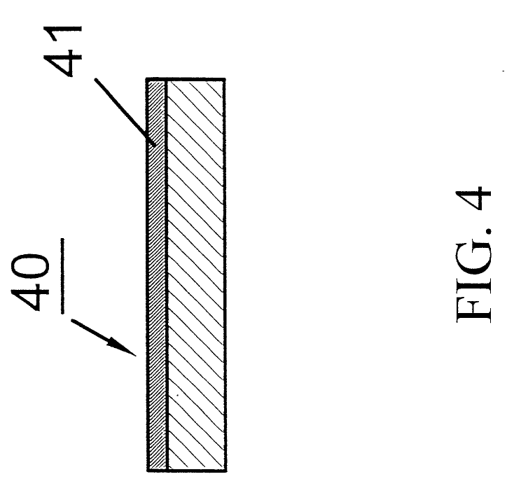

FIGS. 4 to 8 illustrate the processes for manufacturing the first embodiment of the present invention.

In the present embodiment, the conductive material having PTC features is a conductive crystallized polymeric material filled with carbon black, and its volume resistivity is between 10⁻¹ ohm-cm to 10²ohm-cm under room temperature. The conductive crystallized polymeric material is selected from a group consisting of polyethylene, polypropylene, polyvinyl fluoride, and copolymers thereof. In the present embodiment, the conductive crystallized polymeric material was made of mixing polyethylene Petrothene LB832 (a product of Equistar Co. of U.S.) and carbon black Raven450 (a product of Columbian Co. of U.S.) at a weight ratio of 1:1, and then was incorporated into the Brabender mixer and mixed at 210° C. for 8 minutes. Then it was thermal-laminated by a heated press at 175° C. to form a plaque-like conductive polymeric material having PTC features with a thickness around 0.5 mm. A nickel plated copper foil 40 with a thickness of 38 μm is then taken as the metallic electrode of the present invention. There was a metallic nodular layer 41 with a height between about 2 μm to 10 μm on the surface of the nickel plated copper foil 40 for forming a better contact between the metal foil and particles of the carbon black filled in the conductive polymeric material, whereby the interfacial resistance can be reduced.

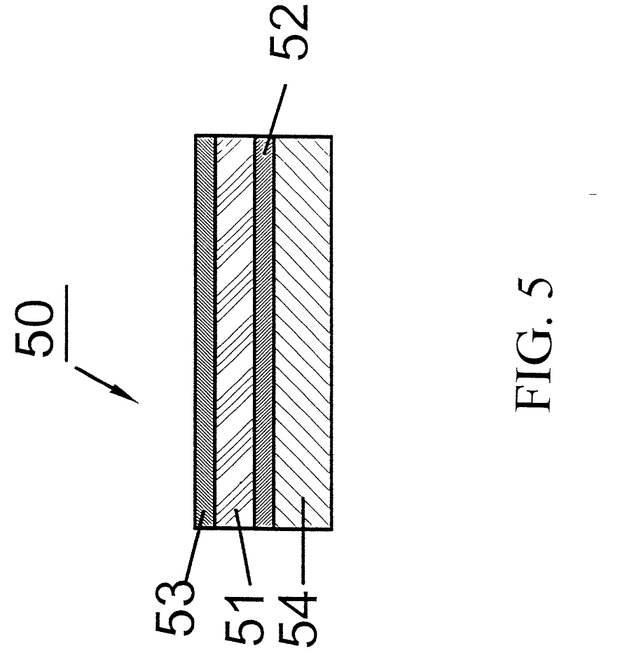

Referring to FIG. 5, two nickel-plated copper foils 40 mentioned above are used as a first metallic electrode 52 and a second metallic electrode 53. A conductive polymeric material layer 51 is disposed between the first metallic electrode 52 and the second metallic electrode 53 and a prepreg material made of a glass fiber cloth impregnated with epoxy resin is taken as an insulating layer 54 on the bottom surface of the first metallic electrode 52. The insulating layer is a laminated material layer made of an epoxy resin layer, a polyimide resin layer, or a glass fiber cloth impregnated with epoxy resin, or a laminated material layer made of a glass fiber cloth impregnated with polyimide. In the present embodiment, a glass fiber cloth impregnated with epoxy resin is used. The second metallic electrode 53, the conductive polymeric material layer 51, the first metallic electrode 52, and the insulating layer 54 together form a multi-layer circuit laminated structure 50.

The method for making the multi-layer circuit laminated structure 50 is as follows: first, the smooth surface of the nickel plated copper foil 52 and the prepreg material 54 are thermal-laminated at 180° C. for 90 minutes to form a preliminary laminated material; it is then further thermal-laminated with the plaque-like conductive polymeric material 51 and the rough surface of the nickel plated copper foil 53 at 175° C. for 10 minutes to form a multi-layer circuit laminated structure 50; the multi-layer circuit laminated structure 50 is irradiated by Co-60 with a dosage of 20 Mrads to cross-link the polyethylene in the conductive polymeric material, whereby enable the plaque-like conductive polymeric material 51 to recollect shapes.

The multi-layer circuit laminated structure 50 is then processed with the conventional manufacturing processes for a printed circuit board, such as developing, etching, drilling, trench dividing, and electroplating. After these processes, the structure is divided into several polymeric circuit protection devices with the same size for further use. The following description employs cross-sectional diagrams to illustrate the manufacturing processes of a polymeric circuit protection device.

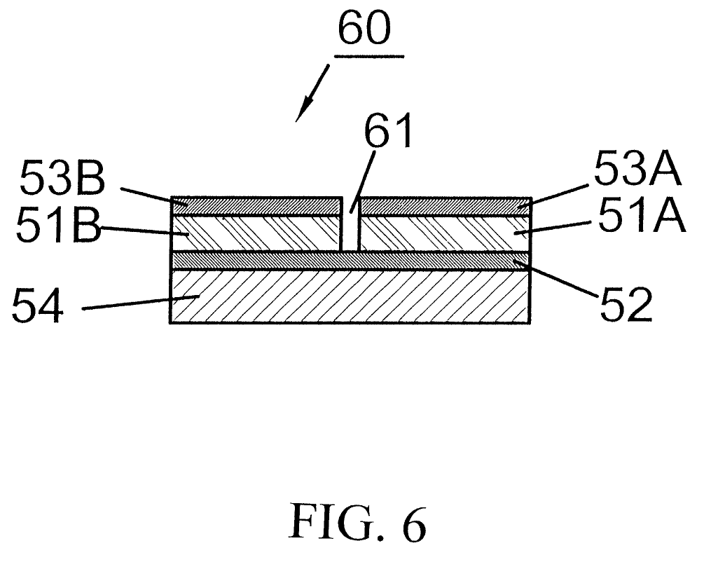

Referring to FIG. 6, an isolation trench 61 penetrating through the second metallic electrode 53 and the conductive polymeric material 51 having PTC features on the semi-finished polymeric circuit protection device 60 is formed by dicing the multi-layer circuit laminated structure 50 with a diamond knife. The bottom of the isolation trench 61 reaches the surface of the first metallic electrode 52 or slightly reaches into the surface of the first metallic electrode 52, but the first metallic electrode 52 shall not be diced through. Etching or laser ablation dicing can accomplish the process.

The second metallic electrode 53 is separated into a first portion 53A of the second metallic electrode and a second portion 53B of the second metallic electrode by the isolation trench 61. The conductive polymeric material 51 having PTC features is also separated into a first portion 51A and a second portion 51B by the isolation trench 61.

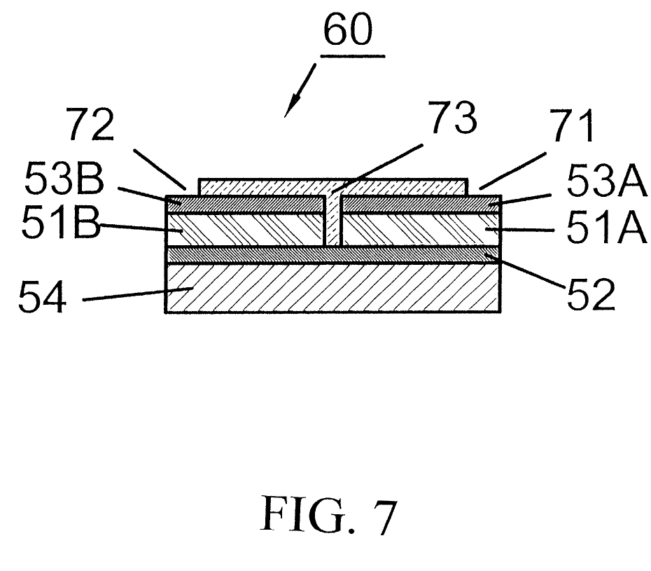

Referring to FIG. 7, the isolation trench 61 is filled with an insulating paint to form an insulating layer 73. The insulating layer 73 covers the whole first portion 53A and the second portion 53B of the second metallic electrode except for the position of a first end electrode 71 and the position of a second end electrode 72.

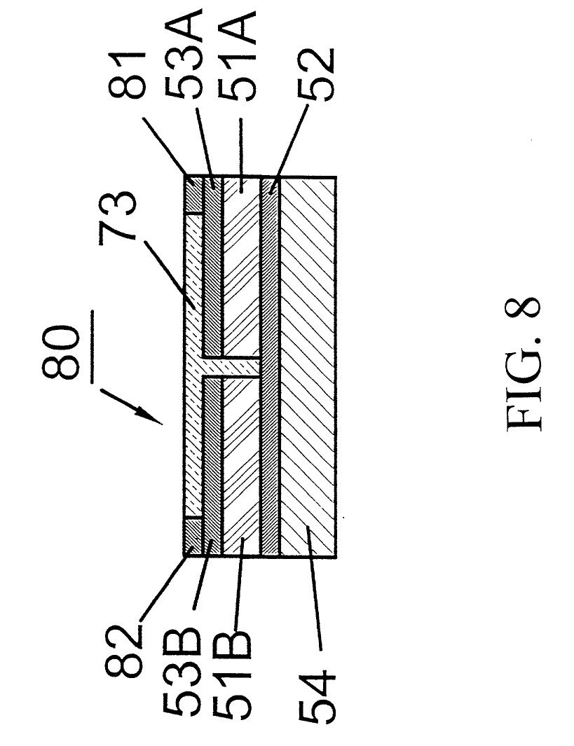

Referring to FIG. 8, a weldable first end electrode 81 and a weldable second end electrode 82 are respectively formed at the corresponding positions of the first end electrode 71 and the second end electrode 72 by screen-printing with tin paste. After the processes mentioned above, the multi-layercircuit laminated structure is divided by a diamond knife, thereby forming individual polymeric circuit protection devices 80.

### Second Embodiment

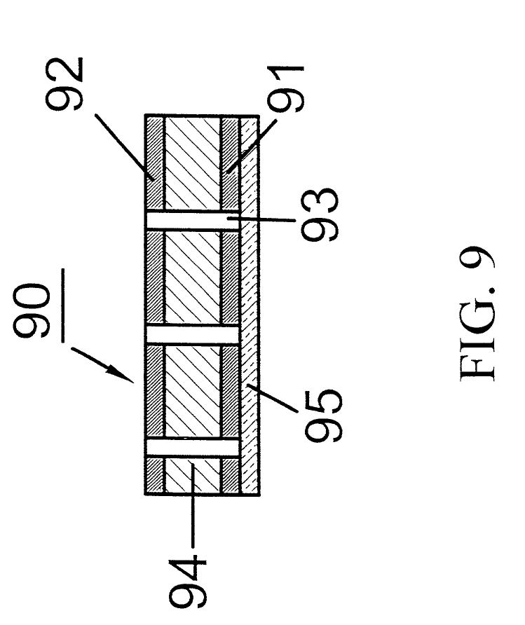

FIGS. 9 to 12 depict the second embodiment of the present invention.

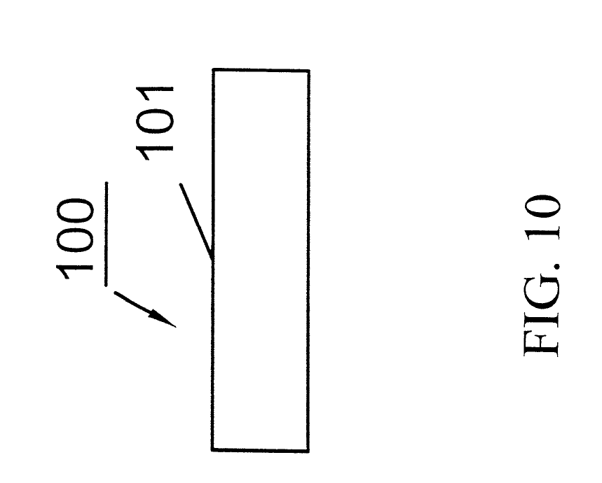

In the present embodiment, the material of the metallic electrode is a double-sided metal foil clad substrate 90 with a copper electrode thickness around 35 μm as shown in FIG. 9, and a copper foil 100 with a thickness of 35 μm as shown in FIG. 10.

Referring to FIG. 9, in the double-sided metal foil clad substrate 90, the first metallic electrode 91 is conducted to the second metallic electrode 92 through the insulating layer 94 by means of a plate through hole 93. Then, an insulating layer 95 is formed by an insulating paint to cover the surface of the first metallic electrode 91.

Afterward, the surface of the second metallic electrode 92 of the double-sided metal foil clad substrate and a first surface 101 of the copper foil shown in FIG. 10 are electroplated by a carbon black composite, wherein 40 grams of boric acid, 6 grams of carbon black XC-72, and 30 grams of nickel (weight of nickel in Nickel Sulphamate solution) are added in 1 liter of electroplating solution. The temperature for the electroplating is 35° C., current density is 5A/dm², and electroplating time is 5 minutes. A continuous porous composite electroplated layer having carbon black and metal (not shown) is formed on the surface of the second metallic electrode 92 of the double-sided metal foil clad substrate and the first surface 101 of the metallic copper foil for further use. The continuous porous structure can make a better contact and have a lower interfacial resistance between the metallic electrode and the conductive polymeric material having PTC features. The Nickel Sulphamate here is a product of Riedel-de Haen Co. of Germany. The degreasing solvent used in a cathode-degreasing step is made by adding 60 grams of degreasing agent in 1 liter of deionized water. The concentration of sulfuric acid used for acid rinse is 10% and carbon black XC-72 is a product of Cabot Co. of U.S.

The conductive polymeric material having PTC features used in the present invention is a conductive crystallized polymeric material filled with carbon black as described in the first embodiment.

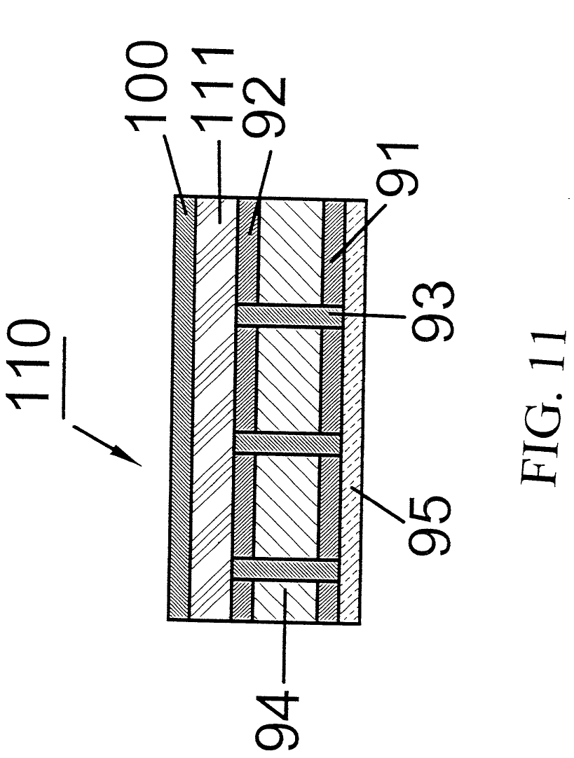

Referring to FIG. 11, the continuous porous composite electroplated layer having carbon black and metal mentioned above is used as an interface to thermal-laminated the second metallic electrode 92 of the double-sided copper metal foil clad substrate and the first surface 101 of the metallic foil with the plaque-like conductive polymeric material 111 at 175° C. for 15 minutes to form a multi-layer circuit laminated structure 1 10.

As described above, the composite electroplating process enables carbon black to be electroplated to the surface of the second metallic electrode 92, thereby forming a continuous porous structural layer. Because the surface of the second metallic electrode 92 and the plaque-like conductive polymeric material 111 both contain carbon black, the carbon blacks in the continuous porous structural layer of the surface of the second metallic electrode 92 and the plaque-like conductive polymeric material 111 take the primary aggregate as its basic unit, and are stacked each other in a resin substrate. The primary aggregate of the carbon black will stack each other to form secondary aggregate and become conductive continuous phase in the polymeric material when the quantity of carbon black is high. The continuous porous structure is constituted by metal, the primary aggregate of carbon black and the secondary aggregate of carbon black. Therefore, the surface of the secondary aggregate of the carbon black will cohere metal when the composite electroplating process is performed. Moreover, the continuous porous structure further forms the secondary aggregate with the plaque-like conductive polymeric material 111, whereby a better contact with a lower interfacial resistance is formed between the metallic electrode and the conductive polymeric material having PTC features (namely, the plaque-like conductive polymeric material 111). The size of the primary aggregate of carbon black varies with different kinds of carbon blacks, the average size is around between 0.1 μm to 0.5 μm. The thickness of the composite electroplated layer (continuous porous structure) is preferably more than two times the size of average diameter of the primary aggregate of carbon black, that is to say, the thickness of the continuous porous structure is preferably more than 0.2 μm.

The structure is then irradiated by Co-60 with a dosage of 20 Mrads to cross-link the polyethylene in the conductive polymeric material, whereby enable the plaque-like conductive polymeric material 111 to recollect shape. Then the structure is proceeded with the same processes as described in the first embodiment.

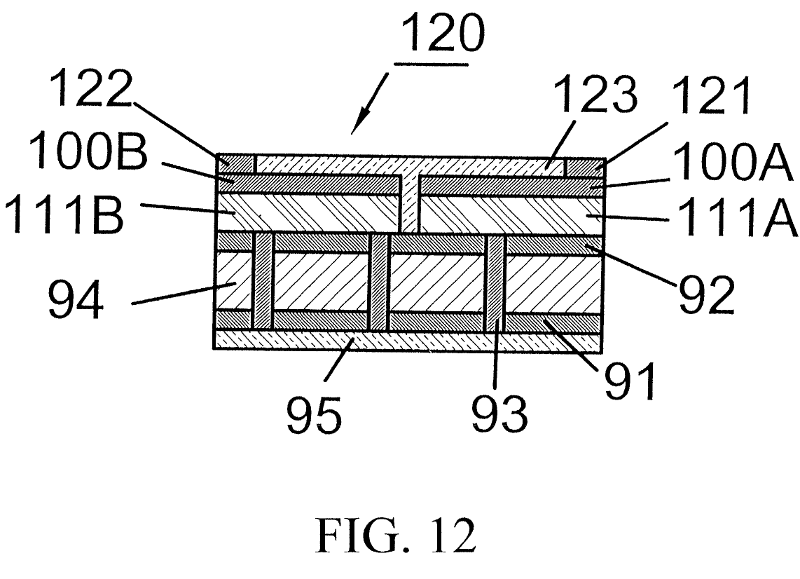

A schematic diagram of the polymeric circuit protection device 120 is illustrated in FIG. 12. The top metallic electrode 100 is separated into a first portion 100A and a second portion 100B by an insulating layer 123. The insulating layer 123 also separates the plaque-like conductive polymeric material 111 having PTC features into a PTC first portion 111A and a PTC second portion 111B. Moreover, a first end electrode 121 and a second end electrode 122 are welded on two ends of the polymeric circuit protection device 120, respectively.

In the present embodiment, the dicing depth of the isolation trench between the PTC first portion 111A and the PTC second portion 111B is more flexible. The dicing depth of the isolation trench can reach the surface of the second metallic electrode 92 of the double-sided metal foil clad substrate, or directly reach the insulating layer 94 of the double-sided metal foil clad substrate by dicing through the second metallic electrode 92. Because the first metallic electrode 91 of the double-sided metal foil clad substrate and the second metallic electrode 92 are conducted to each other by the plate through holes 93, the electrical properties of the polymeric circuit protection device 120 are not affected.

### Third Embodiment

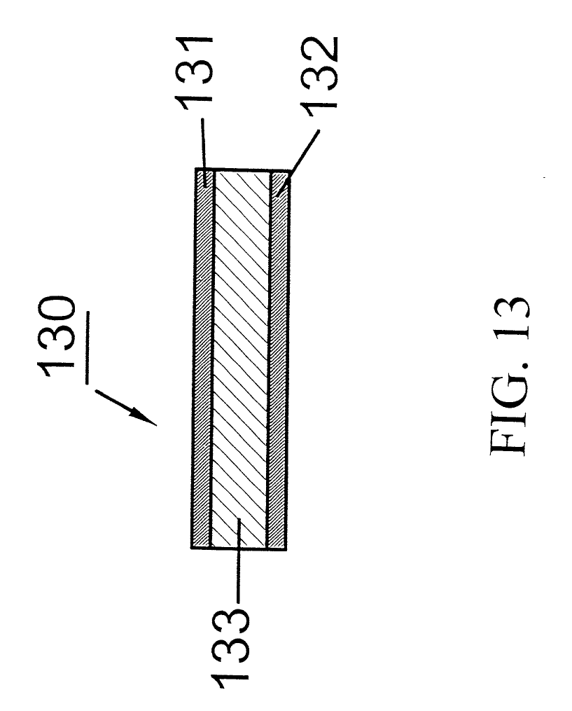

FIGS. 13 to 19 depict the third embodiment of the present invention.

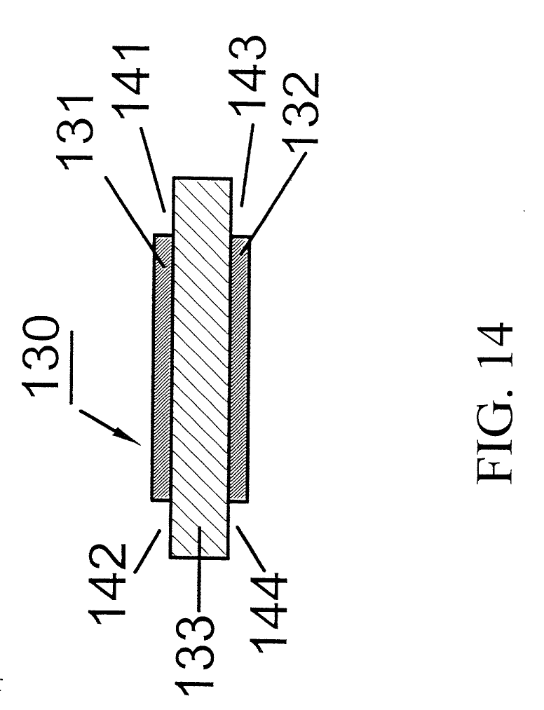

The metallic electrodes used in the present embodiment are the same as those of the second embodiment, which are a double-side metal foil clad substrate with a copper electrode of a thickness around 35 μm and a copper foil with a thickness of 35 μm. The difference is that the top electrode 131 and the bottom electrode 132 of the double-sided metal foil clad substrate 130 are not conductive to each other before composite electroplating (please refer to FIG. 13). Moreover, both the surface of the top electrode 131 and the surface of the bottom electrode 132 of the double-sided metal foil clad substrate of the present embodiment are composite electroplated. Referring to FIG. 14, the top and bottom electrodes 131 and 132 of the double-sided metal foil clad substrate are etched by a manufacturing process of a printed circuit board to remove unwanted parts of the electrodes before the composite electroplating, whereby metallic electrodes do not cover positions 141, 142, 143, and 144 on both sides of the insulating material 133. After the surfaces of the top and bottom electrodes 131 and 132 of the double-sided metal foil clad substrate and a first surface of the metallic foil (not shown) are composite electroplated, a multi-layer circuit laminated structure 130 is made with the same conductive polymeric material and thermal-shaping conditions as described in the second embodiment.

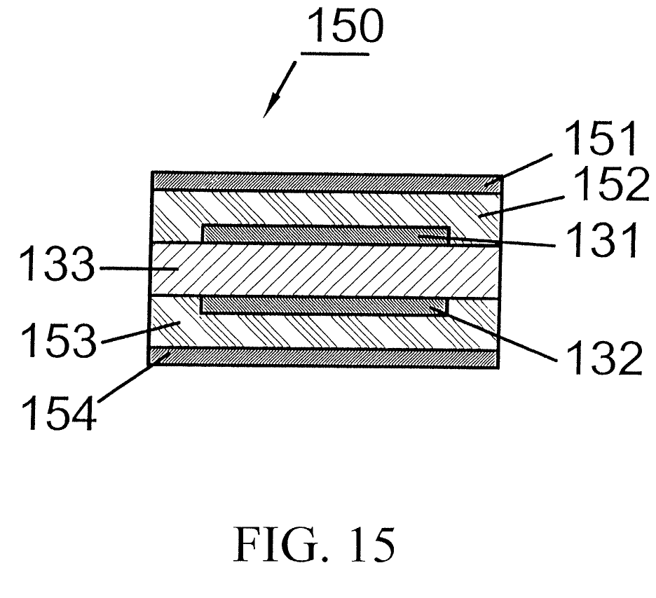

Referring to FIG. 15, reference numerals 152 and 153 are both conductive polymeric material layers having PTC features. Reference numerals 151 and 154 represent metallic foil electrodes after composite electroplating. The conductive polymeric material having PTC features in 152 and 153 is melted and flows due to heat, and then fills in the positions 141, 142, 143, and 144 that are formed after removing metallic electrodes on the top and bottom surfaces of the insulating material 133 of metal foil clad substrate by etching. Then the structure is irradiated by Co-60 with the same dosage as described in the second embodiment to make the conductive polymeric material 152 and 153 having PTC features able to recollect shape.

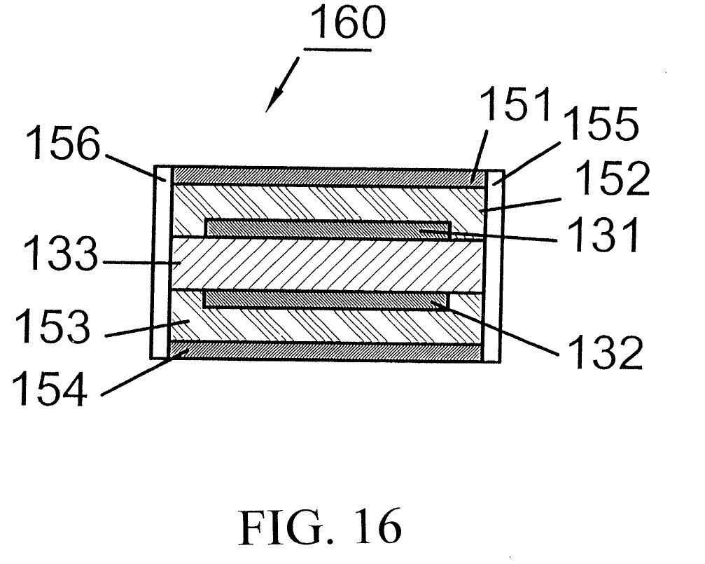

Referring to FIG. 16, plate through holes 155 and 156 are formed by a plating through hole process of a printed circuit board, whereby the topmost metallic electrode 151 and the bottommost metallic electrode 154 are conducted to each other, while the metallic electrodes 131 and 132 are not conducted to each other.

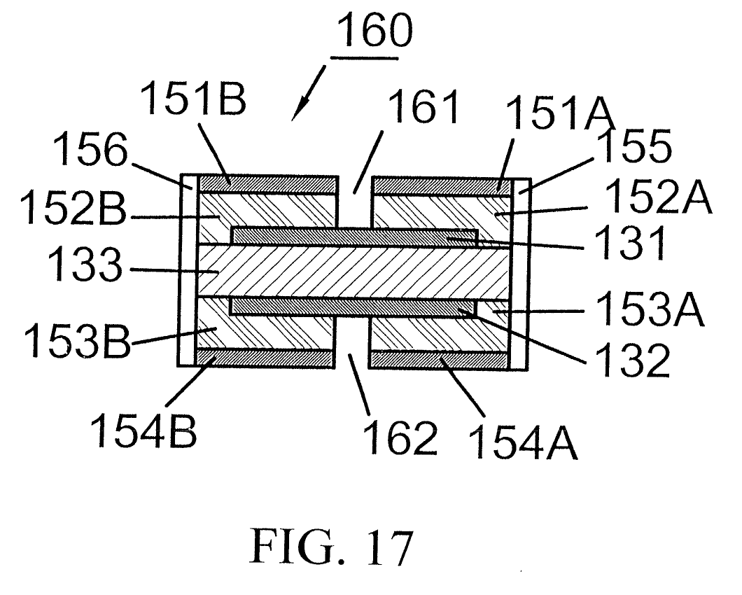

Referring to FIGS. 16 and 17, an isolation trench 161 penetrating through the top metallic electrode 151 and the conductive polymeric material 152 having PTC features of the semi-finished polymeric circuit protection device 160 is formed by dicing the multi-layer circuit laminated structure with a diamond knife. The bottom of the isolation trench 161 reaches the surface of the top metallic electrode 131 or slightly reaches into the surface of the top metallic electrode 131, but the top metallic electrode 131 shall not be diced through. Meanwhile, an isolation trench 162 penetrating through the bottom metallic electrode 154 and the conductive polymeric material 153 having PTC features of the semi-finished polymeric circuit protection device 160 is also formed by dicing the multi-layer circuit laminated structure with a diamond knife. The bottom of the isolation trench 162 reaches the surface of the bottom metallic electrode 132 or slightly reaches into the surface of the bottom metallic electrode 132, but the bottom metallic electrode 132 shall not be diced through. The dicing step can be accomplished by etching the metallic electrodes 151 and 154, and then employing a laser to diced the conductive polymeric materials 152 and 153, thereby forming the isolation trenches 161 and 162.

The metallic electrode 151 is separated into a first portion 115A and a second portion 151B by the isolation trench 161. The isolation trench 161 also separates the conductive polymeric material 152 having PTC features into a PTC first portion 152A and a PTC second portion 152B. Moreover, the isolation trench 162 separates the metallic electrode 154 into a first portion 154A and a second portion 154B and separates the conductive polymeric material 153 having PTC features into a PTC first portion 153A and a PTC second portion 153B.

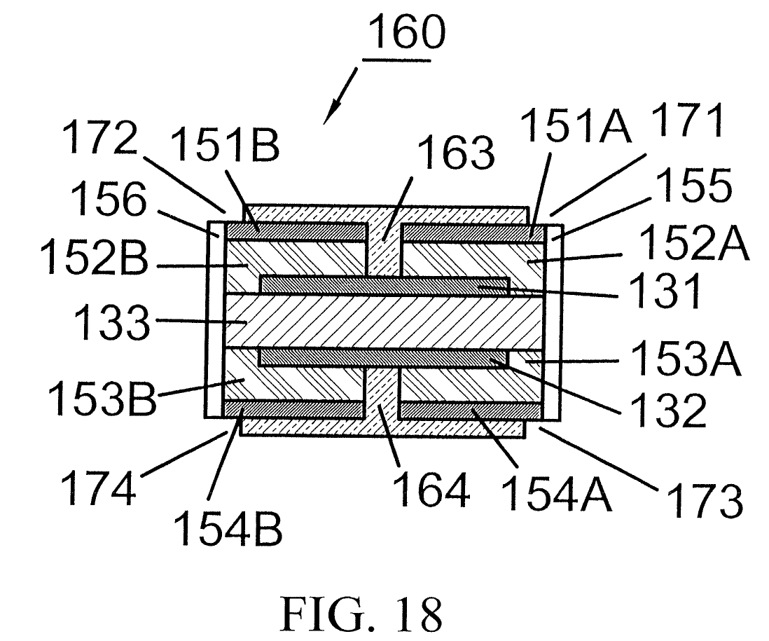

Referring to FIG. 18, an insulating layer 163 is formed by an insulating paint to cover the isolation trench 161, the surface of the first portion 151A of the topmost metallic electrode, and the surface of the second portion 151B of the topmost metallic electrode except for the positions of a first end electrode 171 and a second end electrode 172. In the meanwhile, an insulating layer 164 is formed by an insulating paint to cover the isolation trench 162, the surface of the first portion 154A of the bottommost metallic electrode, and the surface of the second portion 154B of the bottommost metallic electrode except for the positions of a third end electrode 173 and a fourth end electrode 174.

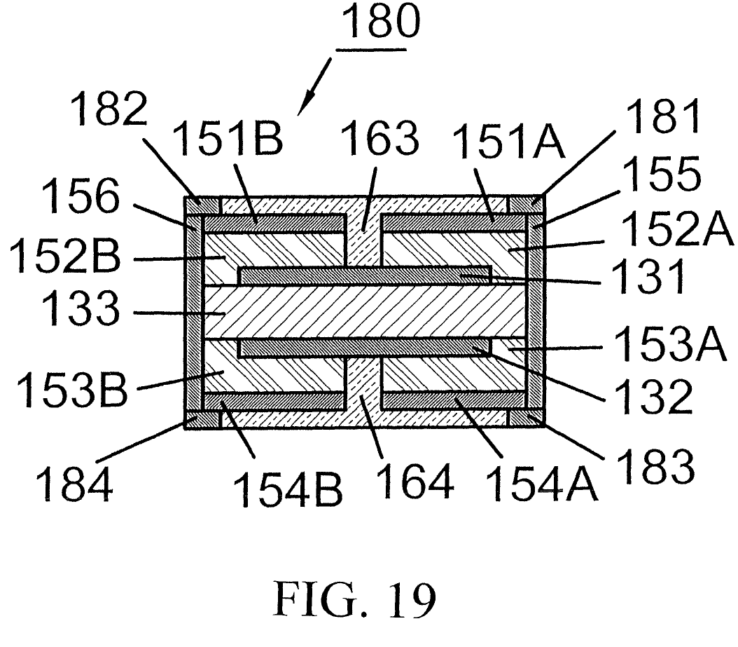

Referring to FIG. 19, a weldable first end electrode 181, a weldable second end electrode 182, a weldable third end electrode 183 and a weldable fourth end electrode 184 are respectively formed on the position of the first end electrode 171, the position of the second end electrode 172, the position of the third end electrode 173, and the position of the fourth end electrode 174 by screen-printing with tin paste. After the mentioned above process the multi-layer circuit laminated structure, a diamond knife to form polymeric circuit protection devices 180 with the same size divides the structure. Among them, the plate through hole 155 is a conducting mechanism for conducting the first end electrode 181 and the third end electrode 183, and the plate through hole 156 is a conducting mechanism for conducting the second end electrode 182 and the fourth end electrode 184. In addition, the plate through hole adopted here can be alternatively replaced by a method for forming end electrodes on ordinary ceramic passive devices after the device is divided into polymeric circuit protection devices 180.

A current flowed into the device from the end electrode 181 first reaches the first portion 151A of the topmost metallic electrode, and then reaches the first portion 154A of the bottommost metallic electrode via the plate through hole 155. Because the electrical conductivity of the metallic electrodes is much higher than that of the conductive polymeric elements having PTC features (152A and 153A), the first portion 151A of the topmost metallic electrode and the first portion 154A of the bottommost metallic electrode have the same potential. The currents reached the first portion 151A of the topmost metallic electrode and the first portion 154A of the bottommost metallic electrode then respectively flow to the PTC first portion 152A and the PTC first portion 153A, and then reach the bottom metallic electrode 132 and the top metallic electrode 131. Then the currents flow to the PTC second portion 152B and the PTC second portion 153B respectively via the conduction of the bottom metallic electrode 132 and the top metallic electrode 13 1, afterward, the currents reach the second portion 151B of the topmost metallic electrode and the second portion 154B of the bottommost metallic electrode. Among them, the current in the second portion 154B of the bottommost metallic electrode reaches another end electrode 182 by means of the conduction of the plate through hole 156. Therefore, the polymeric circuit protection device 180 according to the present embodiment is equivalent to a parallel connection structure of the polymeric circuit protection devices according to the first embodiment, whereby the amount of the current can be increased.

In view of the above, the surface mountable polymeric circuit protection device disclosed by the present invention is unnecessary to provide a conductive mechanism such as plate through holes or external end electrodes. Referring to the polymeric circuit protection device shown in FIG. 8, if a current flows into the device from the second end electrode 82, it would pass through the second portion 53B of the second metallic electrode, the PTC second portion 51B, the first metallic electrode 52, the PTC first portion 51A, the first portion 53A of the second metallic electrode, and finally to the first end electrode 81. Because there is no limit from any internal (plate through holes) or external (external end electrodes) conductive mechanisms, the conductive polymeric element having PTC features is able to expand sufficiently and break down to a discontinuous status when the temperature increases due to a current overload, whereby an optimum disconnection property is obtained when the current is overloaded.

Furthermore, as shown in FIG. 12, a surface mountable polymeric circuit protection device according to another embodiment of the present invention is illustrated. Layers such as the first metallic electrode 91, the insulating layer 94, and the second metallic electrode 92 can directly adopt the double-sided metal foil clad substrate, and various kinds of electrode conduction methods of double-sided metal foil clad substrate can be adopted, thereby broadening the structural designs of the polymeric circuit protection device. Meanwhile, because the strength of the product made of double-sided metal foil clad substrate is superior to the product made of conventional metal foil and conductive polymeric material having PTC features, the product is less likely to be deformed and warped during manufacturing process, and thus has a better dimensional stability.

Also, because a double-sided metal foil clad substrate is used, the processes for manufacturing a printed circuit board can be adopted directly to manufacture the polymeric circuit protection devices. Therefore, the manufacturing processes for the polymeric circuit protection device are much simpler.

Moreover, as shown in FIG. 10, a continuous porous composite electroplated layer having carbon black and metal is formed on the surface of the second metallic electrode 92 of the double-sided metal foil clad substrate by carbon black composite electroplating. Because the combination of carbon black and its secondary aggregate in the continuous porous structure, the continuous porous structure ensures a fine contact and accordingly a lower interfacial resistance between the metallic electrode and the conductive polymeric material having PTC features filled with carbon black. Therefore, the structure has a better performance.

The technical contents and features of the present invention are disclosed above. However, anyone familiar with the technique may possibly make modify or change the details in accordance with the present invention without departing from the technical concepts and spirits of the present invention. For example, changing the polymeric material, adding different kinds of conductive particles, changing composite electroplating conditions or changing the weight ratio of the composite are within the protection scope of the present invention. The protection scope of the present invention shall not be limited to what the embodiments disclosed. The modification and changes that are made without departing from the technical concepts and spirits of the present invention, and should be covered by the claims mentioned below.

We claim:

1. A polymeric circuit protection device, comprising:
a bottom electrode;
a first portion of a conductive polymeric element having PTC features and a second portion of the conductive polymeric element having PTC features, wherein the first portion and the second portion of the conductive polymeric element having PTC features are provided on the bottom electrode;
a first portion of a top electrode, provided on the first portion of the conductive polymeric element having PTC features;
a second portion of the top electrode, provided on the second portion of the conductive polymeric element having PTC features; and
an insulating layer, provided between the first portion and the second portion of the conductive polymeric element having PTC features and between the first portion and the second portion of the top electrode;
whereby the insulating layer prevents the first portion of the conductive polymeric element having PTC features from directly contacting the second portion of the conductive polymeric element having PTC features and prevents the first portion of the top electrode from directly contacting the second portion of the top electrode.

2. The polymeric circuit protection device as claimed in claim 1, further comprising an insulating layer on the first portion and the second portion of the top electrode.

3. The polymeric circuit protection device as claimed in claim 1, further comprising a metallic layer under the insulating layer.

4. The polymeric circuit protection device as claimed in claim 3, further comprising a plate through hole between the metallic layer and the bottom electrode for electrically conducting the metallic layer with the bottom electrode.

5. The polymeric circuit protection device as claimed in claim 1, further comprising an electroplating layer at an interface among the bottom electrode, the first portion of the conductive polymeric element having PTC features and the second portion of the conductive polymeric element having PTC features.

6. The polymeric circuit protection device as claimed in claim 5, wherein the electroplating layer is a continuous porous structure having carbon black secondary aggregate.

7. A method for manufacturing a surface mountable polymeric circuit protection device, comprising the steps of:
arranging a first metallic electrode layer, a first polymeric layer having PTC features and a second metallic electrode layer sequentially and then thermally pressing the layers to form a multi-layer circuit laminated structure;
dividing the multi-layer circuit laminated structure to make the second metallic electrode layer have a second electrode and a third electrode and to make the first polymeric material layer have a first polymeric element and a second polymeric element, wherein the second electrode and the third electrode and the first polymeric element and the second polymeric element are separated from by a trench respectively; and
forming an end electrode to the second electrode and the third electrode respectively.

8. The method for manufacturing a surface mountable polymeric circuit protection device as claimed in claim 7, wherein the insulative material of the trench is an insulative green paint.

9. The method for manufacturing a surface mountable polymeric circuit protection device as claimed in claim 7, further comprising an insulative layer under the first metallic electrode layer.

10. The method for manufacturing a surface mountable polymeric circuit protection device as claimed in claim 7, wherein the second metallic electrode layer comprises a metal selected from the group consisting of copper, nickel, platinum and alloys thereof.

11. The method for manufacturing a surface mountable polymeric circuit protection device as claimed in claim 7, wherein the polymeric material is selected from the group consisting of polyethylene, polypropylene, polyvinyl fluoride and copolymers thereof.

12. A surface mountable polymeric circuit protection device, comprising
a first metallic layer having a first surface and a second surface;
a first polymeric element having PTC features, the first polymeric element comprising a first surface, a second surface and a third surface, the first surface of the first polymeric element being electrically connected to the second surface of the first metallic layer;
a second polymeric element having PTC features, the second polymeric element comprising a first surface, a second surface and a third surface, the first surface of the second polymeric element being electrically connected to the second surface of the first metallic layer;
a first electrode having a first surface and a second surface, the first surface of the first electrode being electrically connected to the second surface of the first polymeric element; and
a second electrode having a first surface and a second surface, the first surface of the second electrode being electrically connected to the second surface of the second polymeric element;
wherein the third surface of the first polymeric element is not directly contacted the third surface of the second polymeric element.

13. The surface mountable polymeric circuit protection device as claimed in claim 12, further comprising a first insulative layer for separating the third surface of the first polymeric element from the third surface of the second polymeric element.

14. The surface mountable polymeric circuit protection device as claimed in claim 12, wherein the second surface of the first electrode is provided with a first end electrode and the second surface of the second electrode is provided with a second end electrode.

15. The surface mountable polymeric circuit protection device as claimed in claim 12, wherein the insulating layer is selected form the group consisting of an epoxy resin layer, a polyimide resin layer, and a glass fiber cloth impregnated with epoxy resin laminated layer and glass fiber cloth impregnated with polyimide laminated layer.

16. The surface mountable polymeric circuit protection device as claimed in claim 12, wherein a metallic layer is provided under the insulative layer.

17. The surface mountable polymeric circuit protection device as claimed in claim 12, wherein a third polymeric element having PTC features and a fourth polymeric element having PTC features are provided under the second metallic layer.

18. The surface mountable polymeric circuit protection device as claimed in claim 17, wherein a third electrode is provided under the third polymeric element having PTC features and a fourth electrode is provided under the fourth polymeric element having PTC features.

19. The surface mountable polymeric circuit protection device as claimed in claim 18, wherein a first end electrode is provided on the second surface of the first electrode; a second end electrode is provided on the second surface of the second electrode; a third end electrode is provided on one end under the third electrode; and a fourth end electrode is provided on one end under the fourth electrode.

20. The surface mountable polymeric circuit protection device as claimed in claim 19, wherein a first plate through hole is provided between the first end electrode and the third end electrode for conducting the first end electrode and the third end electrode; and a second plate through hole is provided between the second end electrode and the fourth end electrode for conducting the second end electrode and the fourth end electrode.
